(19) United States
(12) Patent Application Publication
(10) Pub. No.: US 2006/0285017 A1
(43) Pub. Date: Dec. 21, 2006

(54) System and method for regulating viewing of video entertainment

(75) Inventors: J. Michael Ellis, Holland, MI (US); Karl W. Schripsema, Holland, MI (US); John Hoslett, Holland, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: Spindance, Inc.

(21) Appl. No.: 11/145,615

(22) Filed: Jun. 6, 2005

(51) Int. Cl. H04N 7/16; H04N 9/74

(52) U.S. Cl. 348/584; 725/7

(57) ABSTRACT

A regulator for controlling access to a home video entertainment device includes a signal multiplexer connected to the output of the home video entertainment device. A video signal generated by the regulator may be overlaid with a portion of the video output from the home video entertainment device. If a timer is expired, the regulator video signal is overlaid with all of the video output from the home video entertainment device. If the timer is unexpired, the regulator video signal is overlaid with only a portion of the video output. The duration of the timer can be increased by inserting token into the regulator.

### BACKGROUND OF THE INVENTION

Home video entertainment devices have become increasingly popular, plentiful and visually stimulating. HVEDs include video games, DVD players, and VCRs. For example, television programming can be displayed on 50 inch or larger screens. Video games are increasingly complex and challenging. Thus, HVEDs have become extremely popular.

Due to the nature of HVEDs, a person may become so engrossed in the game that he fails to notice the passage of time. Additionally, children and some adults may have insufficient self-control to properly regulate the use of HVEDs. For example, children may ignore homework or house chores to play video games or watch television. Thus, devices to regulate the use of HVEDs, and in particular video games, have been attempted.

U.S. Pat. No. 5,078,399, issued to John R. Lennon, shows a system for converting a home video game system to a coin operated system. In that system, a video game cannot be initiated until money is placed into the system. They system does not, however, “time out” after a predetermined length of time, but rather continues until the user ceases play or the game finishes.

Another device is shown in U.S. Pat. No. 5,203,848, issued to Jack Y. Wang and assigned to Myson Technology, Inc., shows a video game system where a timer limits the length of time a video game may be played. However, such a system is designed for use exclusively for video games using cartridges and thus would not be useable with many HVEDs, such as DVD players, Sony Playstation® game systems, and Nintendo GameCube® game systems.

U.S. Pat. No. 6,722,984 issued to Kenneth G. Sweeney, Jr. et al. and assigned to Universal Electronics, Inc., shows a controller for a video game where parental controls and a timer are loaded into the controller. The controller is then disabled after a predetermined period of time. While the device could work at stopping a user from playing the video game with the particular controller, it fails to account for a user simply replacing the disabled controller with a different controller.

Similar devices are shown in U.S. Pat. No. 5,882,262, issued to Karsten Ballhom and assigned to and U.S. Pat. No. 5,413,357, issued to Ullrich Schulze et al, both assigned to NSM Aktiengesellschaft.

For various reasons, these previous devices have proven to be ineffectual. An improved system and method for limiting the use of video games is thus highly desirable.

### SUMMARY OF THE INVENTION

A system for regulating the viewing of video entertainment includes a regulator coupled between an HVED and a video display. The regulator provides access to the output from the HVED based upon a timer within the regulator.

If the timer is unexpired, the video and audio output from the HVED is provided to the video display. A signal multiplexer may partially overlay a message from the regulator onto the HVED video output. Thus, the output from the regulator may be comprised by the video from the HVED as well as the output from the regulator. Generally, the output from the regulator appears for short periods of time so as not detract from the HVED content.

If the timer is expired, the video output from the HVED is overlaid with a signal from the regulator, such that the output from the HVED is substantially not viewable on the video display. A portion of the video from the HVED can be seen at the edges of the screen.

In order to increase the duration of the timer, the regulator is provided with a token slot. As tokens are deposited into the slot, the duration of the timer is increased. Thus, a parent or teacher can provide tokens for use with the HVED.

In one mode of operation, the video output from the HVED is overlaid with a signal from the regulator irregardless of whether the timer is expired. This allows for access to the HVED to be completely disabled.

In another mode of operation, there is never any overlaying of the regulator signal with the video output from the HVED even if the timer is expired. This allows for unfettered access to the HVED.

In yet another mode of operation, the regulator can be paused. In this mode, the timer is disabled from decrementing and the video signal from the signal regulator is completely overlaid on the video output from the HVED. This allows a user to pause the operation of the regulator in order to attend to other tasks.

These and other objects, advantages and features of the invention will be more readily understood and appreciated by reference to the detailed description of the drawings.

### BRIEF DESCRIPTION OF THE DRAWINGS

FIG. 1 shows a television, a home video entertainment device and a regulator.

FIG. 2 is a perspective view of the front of the regulator.

FIG. 3 is a perspective view of the back of the regulator.

FIG. 4 is a block diagram of the regulator.

FIG. 5 is a flow chart showing the operation of the regulator.

### DETAILED DESCRIPTION OF THE DRAWINGS

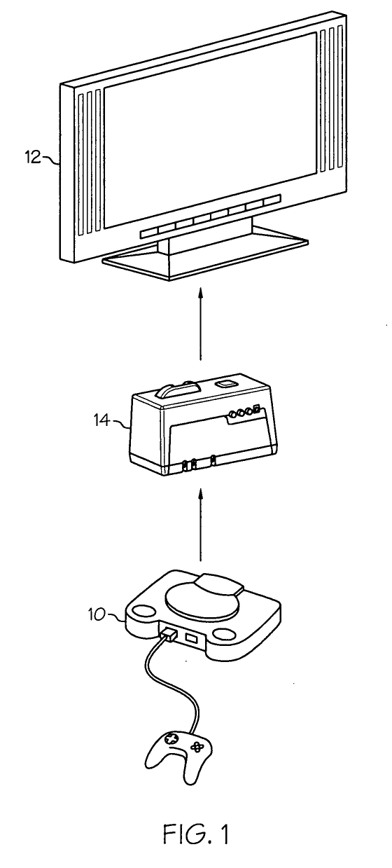

FIG. 1 shows HVED 10 connected to video display 12 through regulator 14. HVED 10 could be a video game, a DVD player, cable television box, satellite tuner or any other similar peripheral enabling video to be displayed on video display 12. Video display 12 could be any video display, such as a conventional CRT television, HDTV or projector TV.

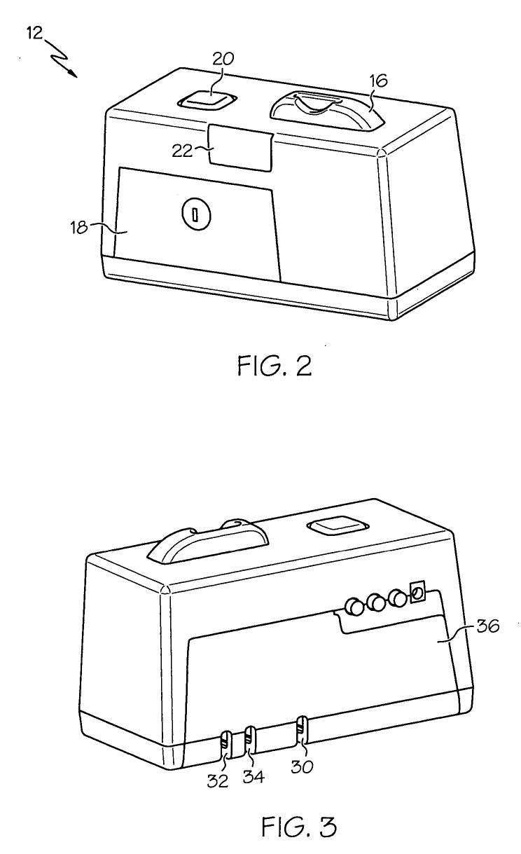

FIG. 2 shows regulator 14 in more detail. Regulator 14 includes token slot 16. A user places token into token slot 16. The tokens used for token slot 16 could be any type of readable token. Further, token slot 16 could be a card reader. Door 18 is lockable. When unlocked, door 18 is open allowing access to a token receptacle within regulator 14.

In operation, a user places tokens into slot 16. Each token sets a timer within regulator 14 giving the user a predetermined period of time to use HVED 10. When the time has expired, regulator 14 overlays or disables the video signal from HVED 10 to video display 12, rendering the HVED unusable. In one embodiment, composite signals such as those from a video game are overlaid with another video signal, while the signals for RF signals such as cable television are switched. If the user desires to use HVED 10 for an additional period of time, a user must put additional tokens within regulator 14.

Pause button 20 located on regulator 14 allows the pausing of the timer within regulator 14. Pause button 20 is a pause control for regulator 14. For example, the user can pause the timer by pressing pause button 20, and can leave the game for a period of time. When pressed, pause button 20 disrupts the video signal from HVED 10 to video display 12. The timer within regulator 14 is also disabled. When a user returns, the user presses pause button 20, restoring the video signal from HVED 10 to video display 12. Thus, a user is able to utilize the full amount of time provided by each token inserted into regulator 14.

Display 22 provides information to a user about the operation of regulator 14. For example, display 22 might provide an indication of the status of regulator 14 as well as the amount of time remaining before the regulator disables the video signal from HVED 10.

FIG. 3 shows the rear of regulator 14. Slot 30 provides a channel for a cable from HVED 10. Slots 32, 34 provide channels for cables attaching RF cables from CATV and to video display 12. Door 36 is removable to allow attachment of the various devices to regulator 14.

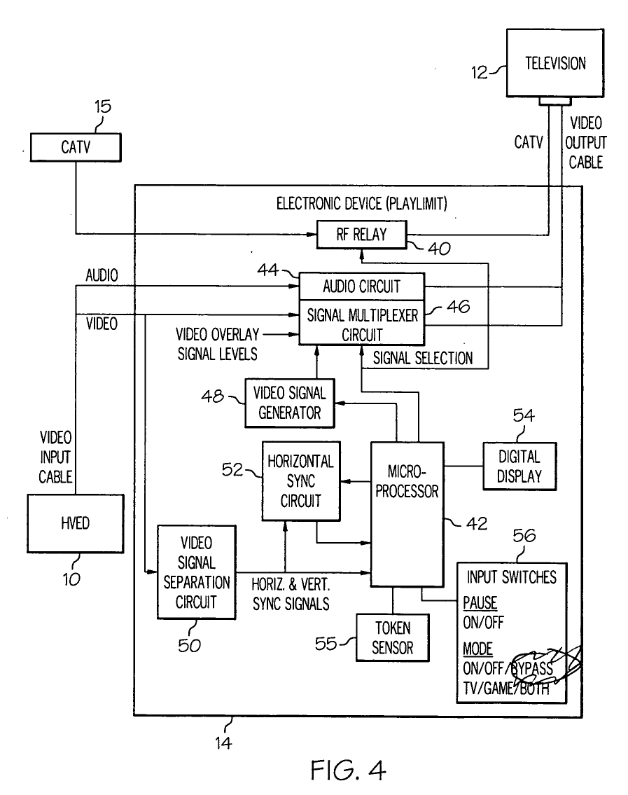

FIG. 4 shows a block diagram of regulator 14. CATV 15 is connected to the input of video relay 40. Video relay 40 could be a single pole double throw switch. The output of video relay 40 is attached to the input of video display 12. Video relay 40 is also connected to processor 42. Among other things, processor 42 controls the state of video relay 40, and thus controls whether the video signal from CATV 15 is provided to video display 12.

The audio output of HVED 10 is connected to audio circuit 44 while the video output of HVED 10 is connected to signal multiplexer circuit 46. Audio circuit 44 combines the incoming signal from HVED 10 with audio signals generated by regulator 14. For example, processor 42 may generate tones to indicate the insertion of a token into token slot 16 or tones indicating that time is about to expire.

Signal multiplexer circuit 46 combines incoming video signals from HVED 10 with the video signal generated by video signal generator 48. Processor 42 selects which signal is provided by the output of signal multiplexer circuit 46. Signal multiplexer circuit 46 thus switches between the video signals from HVED 10 and the pre-defined video signals video signal generator 48.

Video signal generator 48 could be a separate component within regulator 14, or it could be contained within processor 42. A suitable processor would be the PIC16F72 distributed by Microchip Technologies, Inc.

Video signal separation circuit 50 extracts vertical and horizontal sync signals from the video signal from HVED 10. The sync signals are used by processor 42 to determine where any overlay should be transmitted in order to overlay the video signal from video signal generator 48 onto the desired portion of the video signal output from regulator 14.

Horizontal synch circuit 52 is also coupled to the video signal separation circuit 50. Horizontal synch circuit 52 maintains horizontal video signal synchronization between the output of video signal generator 48 and the output from HVED 10.

Processor 42 is connected to digital display 54. Digital display 54 is the same as display 22 from FIG. 2. Digital display 54 could be a seven segment LED or LCD display. It could be a simple countdown timer indicating the time left to use HVED 10, or it could present other information to the user.

Token sensor 55 detects when tokens are inserted into regulator 14 by way of token slot 16. When a token is place within slot 16, it rolls past token sensor 55. Token sensor 55 detects the movement and registers the insertion of a token with processor 42.

Input switches 56 may contain three switches. One switch corresponds to pause button 20. When pressed, regulator 14 is paused. On/off/bypass switch indicates which of three modes regulator operates.

The “OFF” position indicates that regulator 14 is disabling the video from any controlled devices. The “BYPASS” position indicates that regulator 14 will not interfere with any video signal, while the “ON” position indicates that regulator 14 operates in its usual manner of allowing the video signal through from select devices.

The “TV/GAME/BOTH” switch selects which device is controlled. In the “TV” position it controls the signal from the CATV 15 to the Video Display 12. In the “Game” position it controls the signal from the HVED 10 to the Video Display 12. In the “Both” position regulator 14 controls both signals.

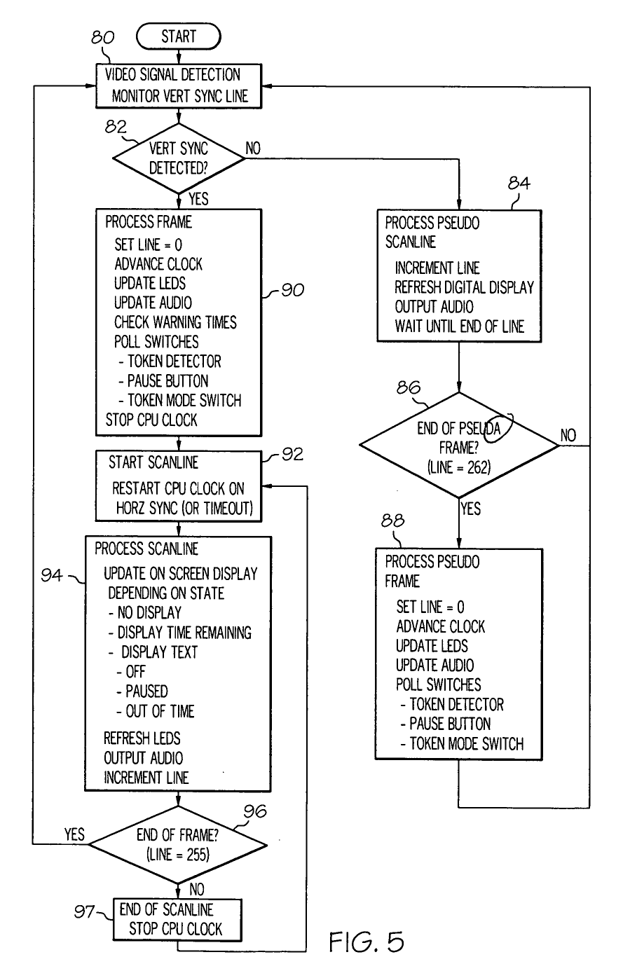

FIG. 5 shows the operation of regulator 14. A video signal from HVED 10 is detected by monitoring the vertical sync output from video signal separation circuit 50 [box 80].

If the video signal is not detected by processor 42 [box 82], a pseudo scan line is generated [box 84]. LINE, a variable equal to the horizontal scan line, is incremented, digital display 54 is refreshed, and any audio is outputted. If the end of the pseudo frame is not detected [box 86], the process repeats.

If the end of the pseudo frame is detected, the pseudo frame is processed [box 88]. LINE is set to zero. The clock is advanced. The digital display 54 is updated, and various switches are polled. The token detector, the pause button and the token mode switch are all polled.

The process then repeats.

Returning to box 82, if a vertical sync is detected, a frame is processed [box 90]. LINE is set to 0. The clock is advanced. The digital display and audio are updated and the switches are polled. The warning time is also checked and compared to the clock. The clock of processor 42 is paused.

The scanline is then started [box 92]. The clock of processor 42 is resumed.

Processing of the scanline then occurs. [box 94]. First, the screen display is updated depending upon the state. The three states could be “No Display”, “Time remaining” and “Text Display.”

“No display” indicates that no video is generated by regulator 14, thus providing no interference with any of the video signal from HVED 10. This occurs if regulator 14 has been bypassed or if time has not expired and the time remaining is not displayed. If regulator 14 is in bypass mode, HVED 10 can be accessed without regard to tokens or time remaining.

In “Time Remaining” mode, the time remaining before expiration is displayed. This information is overlaid on the screen for a brief period of time so as to not interfere with HVED content/game play.

In “Display text” mode, a preselected text is displayed, depending upon the status. If regulator 14 is paused, then a message such as “PAUSED” would be displayed. If the mode is “OFF”, then a message such as “OFF” is displayed. If the user has used all of the allotted time, then the message “OUT OF TIME” is displayed.

Digital display 54 is refreshed, and the audio is outputted. LINE is incremented.

If an end of frame is detected [box 96], then the process repeats. If not, the scanline has been completed and the clock of processor 42 is stopped [box 97]. The process then repeats.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

1. A system for regulating the use of a peripheral with a video display comprising:
a signal multiplexer coupled to a peripheral video output and a video signal generator, the signal multiplexer having a signal multiplexer output for coupling to a video display; and
a processor controlling whether the signal multiplexer output is coupled to the peripheral video output or the video signal generator.

2. The system of claim 1 where the processor is responsive to a timer such that the peripheral video output is coupled to the signal multiplexer output for a duration.

3. The system of claim 2 further comprising:
a pause control for pausing the timer.

4. The system of claim 3 further comprising means for increasing the duration.

5. The system of claim 4 where the means for increasing the duration includes a token sensor.

6. The system of claim 5 further comprising a digital display.

7. A system for regulating the use of a peripheral with a video display comprising:
a signal multiplexer coupled to a peripheral video output and a video signal generator output, the signal multiplexer having a signal multiplexer output for coupling to a video display; and
a processor for overlaying a portion of the video signal generator output on the peripheral video output.

8. The system of claim 7 where the processor is responsive to a timer such that the peripheral video output is coupled to the signal multiplexer output for a duration.

9. The system of claim 8 further comprising means for increasing the duration.

10. The system of claim 9 further comprising a pause control for pausing the timer.

11. The system of claim 10 where the means for increasing the duration includes a token sensor.

12. The system of claim 11 where the video signal generator output includes a timer status indicating the duration.

13. The system of claim 12 further comprising a horizontal synch circuit.

14. The system of claim 13 further comprising an RF relay.

15. The system of claim 14 further comprising an audio circuit for generating an audio output.

16. A method of operating a system comprising:
generating a video signal overlay;
checking a timer; and
if the timer has not expired, overlaying a portion of the video signal overlay with a first video signal.

17. The method of claim 16 further comprising:
if the timer has expired, then overlaying the first video signal with the video signal overlay so that the first video signal is not viewable.

18. The method of claim 17 further comprising:
if a pause control has been activated, then pausing the timer.

19. The method of claim 18 further comprising:
if the timer has not expired, generating as a part of the video signal overlay a timer signal indicative of the timer.

20. The method of claim 19 further comprising:
if the timer has expired, generating as part of the video signal a first message.

21. The method of claim 20 further comprising:
detecting a vertical synch signal.

22. The method of claim 21 further comprising:
detecting a horizontal synch signal.
